(19) United States
(12) Patent Application Publication
(10) Pub. No.: US 2024/0302138 A1
(43) Pub. Date: Sep. 12, 2024

(54) PROTECTIVE MATERIAL IN ROLL FORM AND METHOD FOR THE PRODUCTION THEREOF

(71) Applicant: SAATI S.P.A., Appiano Gentile (CO) (IT)

(72) Inventors: Franco MERLETTI, Appiano Gentile (IT); Thomas DELLA VEDOVA, Appiano Gentile (IT); Carmine LUCIGNANO, Appiano Gentile (IT); Paolo CANONICO, Appiano Gentile (IT)

(21) Appl. No.: 18/264,525

(22) PCT Filed: Mar. 8, 2022
(86) PCT No.: PCT/IB2022/052042

§ 371 Date: Aug. 7, 2023

(30) Foreign Application Priority Data
Mar. 10, 2021 (IT) 102021000005618
Mar. 10, 2021 (IT) 102021000005624
Apr. 23, 2021 (IT) 102021000010340

(51) Int. Cl. F41H 5/04; B29C 70/50; B29L 31/00

(52) U.S. Cl. CPC F41H 5/0478; B29C 70/506; B29L 2031/768

(57) ABSTRACT

A protective material in roll form comprising a laminate fabric with a matrix formed of one or more thermoplastic films; the fabric is advantageously an aramid fabric. The production method of the protective material comprises the direct lamination of a fabric with one or more thermoplastic films, by means of a continuous production line that operates at a temperature between 100 and 250° C. and a pressure from 5 to 60 bar, applied for a time of at least 30 seconds.

### BACKGROUND OF THE INVENTION

The present invention concerns a protective material in roll form and a method for the production of said material.

More specifically, the present invention refers to a material used as a base for the production of articles provided with ballistic protection, in particular for the production of bullet-proof vests also having a given level of stab proof protection (against stab or spike).

The field of personal protection, as meant in this document, is characterized by the use of a wide range of materials, with the aim of responding especially to specific requirements in terms of ballistic performance and resistance to stabbing, but also to requirements commonly known and considered important according to market surveys, such as flexibility, optimization of manufacturing waste, etc.

A ballistic solution for “soft armoring”, as the functional part of a bullet-proof vest is called, is composed of many layers of different types of materials, each of which contributes totally or partially to one or more functions.

The list of materials used to compose a ballistic solution is very long and the combination of said materials is optimized especially thanks to a trial-and-error approach where the first test is defined on the basis of a starting database.

The products used include: aramid fabrics, polyethylene fabrics, aramid unidirectionals, polyethylene unidirectionals, aramid felts, metallic mesh, metallic plates, barriers with metallic or ceramic flakes, laminates made of resins/films on aramid or polyethylene fabrics.

Besides purely ballistic, or stab proof or spike proof or trauma reducing materials, a type of products exists that is able to effectively perform more than one of these tasks: MTP (Multi Threat Penetration) materials.

The stab proof materials analogous to the one described here are in general produced by means of a four-stage process:
lamination of a thermoplastic film or coating of a thermosetting resin, also more generically called matrix, on an aramid fabric in order to make it integral with said fabric;
cutting of the roll of bonded material into sheets of defined length;
layering of single sheets alternating with appropriately sized sheets of material with release coating;
insertion of the layered package into a static press and application of a pressing cycle with defined temperature, pressure and duration.

The resulting product is a finite number of semi-rigid flat sheets with ballistic and stab proof properties determined by various factors: choice of the fabric, matrix, percentage by weight of the latter with respect to the fabric, chemical composition and degree of interpenetration of the matrix with it.

Manufacture of the end product consists in cutting said sheets, and if necessary other materials to be used in combination, according to the shape of a bullet-proof vest, in accordance with the guidelines of the relevant reference standard, and making up the vest according to an arrangement of the layers designed to meet the relevant performance requirements.

### SUMMARY OF THE INVENTION

The aim of the present invention is to provide a protective material in roll form, improved in comparison with the materials currently in use for the production of articles provided with ballistic protection, in particular for the production of bullet-proof vests also having a given level of stab proof protection (against stab or spike).

Within this aim, an object of the invention is to provide a material that can be advantageously used by all manufacturers, not equipped with infrastructures for shaping a large number of flat sheets, enabling them to work with MTP materials in the same way as they work with fabrics, unidirectionals, etc.

In fact, the machinery normally used for producing protective vests from a fabric use said fabric in the initial form of a roll. This machinery is therefore not compatible with the conventional MTP materials in the form of sheets.

Another object of the invention is to provide a material that allows waste optimization, using the same templates, as a result of the availability of a continuous roll instead of single pieces.

A further object of the invention is to provide a material in roll form that can be used in place of the conventional sheet materials and has optimal stab proof properties and improved ballistic resistance.

A further object of the invention is to provide a material with improved flexibility.

These and other objects, which will become clearer below, are achieved by a protective material in roll form, a method and a plant for the production of said material, as claimed in the appended claims.

### BRIEF DESCRIPTION OF THE DRAWINGS

Further characteristics and advantages of the subject of the present invention will become clearer from an examination of the description of a preferred but non-exclusive embodiment of the invention, illustrated by way of non-limiting example in the attached drawings, in which:

FIG. 1 is a schematic view illustrating an example of a plant for production of the material according to the invention.

### DETAILED DISCLOSURE OF PREFERRED EMBODIMENTS

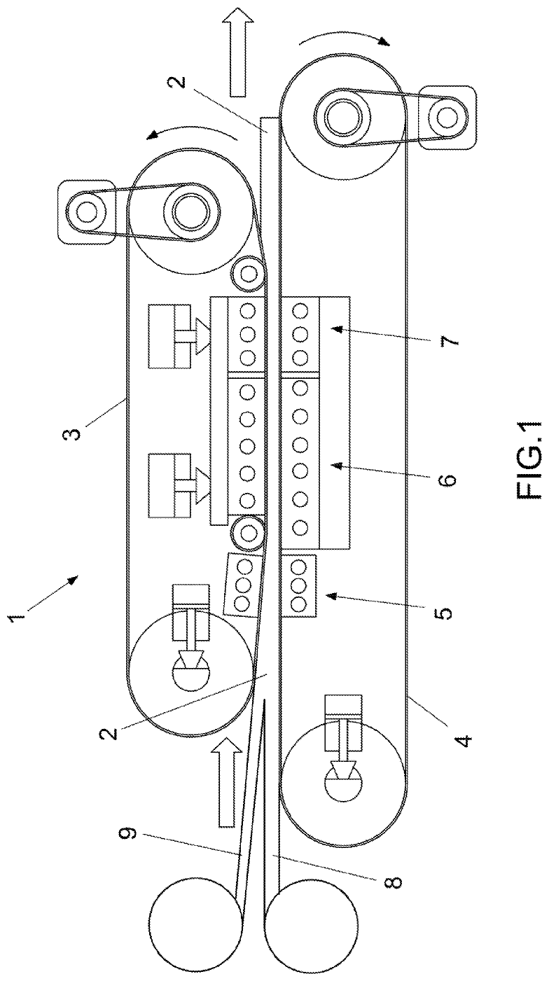

With particular reference to the numerical symbols of the abovementioned FIGURES, the composite material production method according to the invention is carried out by means of a plant schematically illustrated in FIG. 1 and indicated as a whole by the reference number 1.

The laminated material according to the invention, generally indicated by the reference number 2, is produced by direct continuous lamination of an aramid fabric 8 with one or more thermoplastic films 9. It is produced by means of a production line able to operate at high temperatures, from 100 to 250° C., and high specific pressures, from 5 to 50 bar, applied for a minimum time of 30 seconds (belt drum calendering machine).

The plant 1 comprises an upper belt 3 and a lower belt 4 which convey the laminate 2 through a first pre-heating section 5, which is at a temperature preferably ranging from 100 to 230° C., and a second section 6 for heating to a temperature preferably ranging from 130 to 250° C. and compressing at a pressure preferably ranging from 5 to 60 bar.

A cooling section 7 is also provided which, before the film 2 exits the plant, cools it to below the melting temperature of the component polymer material, for example a temperature ranging from 20 to 70° C., to allow stabilization of the laminate obtained.

The production of flexible MTP systems in roll form with analogous performances, according to the invention, can be carried out starting from the following components: woven or non-woven fabrics composed of high tenacity and/or high modulus textile fibers typically used for ballistic applications or for the production of composites such as aramid fiber, high density polyethylene (UHMWPE), polypropylene, polyamide, polyimide, polyester, polyarylester, PBO, S-glass, E-glass, carbon fiber.

The following table shows an embodiment of the laminate material 2 of the invention, laminate S and laminate D, respectively, consisting of an aramid fabric 8 with weight of 185 g/m², preferably made of high tenacity para-aramid fibers. In the laminate S shown in the table, the fabric 8 is coupled with one single layer of polyethylene-based film 9 with 21% by weight of film 9 based on the total weight of the laminate 2. In the laminate D shown in the table, the fabric 8 is coupled with two layers of polyethylene-based film 9, in amount of 35% by weight based on the total. Furthermore:
sheet S is the prior art material with one single layer of film;
roll S is the laminate material of the invention with one single layer of film;
sheet D is the prior art material with two layers of film;
roll D is the material of the invention with two layers of film.

| Ballistic | | | |
|---|---|---|---|
| protective | Area density of single | V50 @ 6.4 kg/m² | |
| material | layer of product [g/m²] | [m/s]* | KR1-E2 kg/m²]** |
| Sheet S | 235 | 450 | 6.6 |
| Roll S | 235 | 465 | 6.6 |
| Sheet D | 285 | 400 | 6.6 |
| Roll D | 285 | 420 | 6.6 |

in which:
*V50 test according to AEP2920 with 9 mm DM11 A1B2 at an area density of 6.4 kg/m² of the ballistic package composed of several layers of the material indicated in the second column of the table.
**KR1 test according to the Home_Office_Body_Armour_Standard (2017), E2 = 36J.

The columns of the present table show that, compared to the conventional sheets S and D, the material of the invention in flexible roll S and flexible roll D has the same stab proof performance as clearly shown by the identical area density values of the reference packages KR1-E2, required to obtain the same protection level KR1.

At the same time the column V50 compares the ballistic values of V50 indicative of the effectiveness of the product in stopping a 9 mm projectile and shows that the products in roll form S and D of the invention perform better than the corresponding sheets S and D, due to the greater flexibility of the former compared to the analogous products of the prior art.

Among the textile fibers used for the fabric 8, with particular reference to aramid and high density polyethylene fibers, deniers ranging from 110 to 3300 dtex are selected.

For each specific fabric there is an ideal amount of matrix for obtaining optimal ballistic and stab proof performances, in turn linked to the chemical composition of the matrix and the way in which it interacts with each specific fiber.

By way of example the following table shows embodiments of the invention consisting of aramid fabrics 8 with different fiber weight and denier that can provide similar performances as the weight ratio between matrix 9 and fabric 8 varies.

| | | | | | KR1**E2 [kg/m²] |
|---|---|---|---|---|---|
| | | Area density | Area density | | -Number of layers |
| | Fiber denier | of single | of single | V50*@ | of laminate |
| Laminate | of fabric 8 | layer of fabric 8 | layer [g/m²] - | 6.4 kg/m² | composing the |
| material | (dtex) | [g/m²] | % matrix | [m/s] | ballistic package |
| Roll S1 | 1100 | 185 | 235 - 21 | 450* | 6.6 - 28** |
| Roll S2 | 940 | 200 | 270 - 26 | 440* | 6.2 - 23** |
| Roll S3 | 3300 | 290 | 365 - 21 | 438* | 6.6 - 18** |

in which:
*V50 test according to AEP2920 with 9 mm DM11 A1B2
**KR1 test according to the Home_Office_Body_Armour_Standard (2017), E2 = 36J

In particular it can be seen from the table that the rolls S1 and S3 with very different fiber denier (second column) and area density of the base fabric (third column) can provide very similar performances against the projectile (column V50).

With regard to stab proof protection, identical performances can be seen between the material in roll form of the invention and the sheets of the prior art (column KR1-E2), maintaining the same matrix percentage (fourth column).

At the same time, the use of a different fiber, as for Roll S2, selecting a higher percentage of matrix 9, is able to improve performance in terms of stab proof protection compared to Roll S1. In the column KR1-E2 it can be seen that the area density value required to obtain a given KR1 is lower, with a minimum loss in the V50 (fifth column).

Among the matrixes that can be advantageously used, thermoplastic or thermosetting resins are selected having chemical composition based on polymers such as: polyethylenes, polyurethanes, polypropylene, polyamide, polyester, polyarylester, polyvinyl butyral, polycarbonate, phenolic, epoxy, phenoxy, polyurethane and acrylic resins.

The amount of matrix 9 required in percentage based on the total weight of the laminate 2 can vary from 10 to 45%, and the ideal amount is closely correlated with the characteristics of the woven or non-woven fabric with which it is combined.

In the case of the fabric 8, in addition to the area weight and the denier of the fiber/s, the number of threads per centimeter and the type of weave selected are important parameters.

By way of example, the following table shows laminate materials 2 of the invention which are very similar to one another, made from fabrics with different weaves, all with aramid fabric 8 having 185 g/m² weight, 1100 dtex fiber and 21% polyethylene film (one single layer):

| | Area density of | | | |
|---|---|---|---|---|
| | single layer of | | V50*@ 6.4 | |
| Laminate | laminate 2 | Weave of | kg/m² | KR1**E2 |
| material | [g/m²] | fabric 8 | [m/s] | [kg/m²] |
| Roll S1 | 235 | Plain | 450 | 6.6 |
| Roll S4 | 235 | Batavia 2/2 | 488 | 5.9 |
| Roll S5 | 235 | Panama 2/2 | 432 | 6.1 |
| Roll S6 | 235 | Batavia 4/4 | 469 | 5.9 |

in which:
*V50 test according to AEP2920 with 9 mm DM11 A1B2
**KR1 test according to the Home_Office_Body_Armour_Standard (2017), E2 = 36J

From this table it can be seen, in particular from the column KR1-E2, that the stab proof performances of all the laminates obtained from “open” fabric weaves (S4, S5, S6) allow a significant lowering in the area densities of the respective reference packages, required for obtaining the desired level KR1-E2.

On the contrary, the column V50 shows that the ballistic properties of the products with weaves alternative to plain weave do not undergo a generic improvement, but the Batavia structures can be identified as the preferable weave, particularly the structure S4.

In the light of all the above considerations, a series of values are specified, within the ranges indicated for the critical parameters analyzed so far, which optimize the performances of the laminate material of the invention:
aramid fiber fabric 8 with denier 670, 940, 1100, 1320, 3140, or 3300 dtex;
content of matrix 9 between 15% and 25% by weight for deniers above 3000 dtex and matrix percentage between 20% and 40% by weight for intermediate deniers between 670 and 1320 dtex;
the Batavia 2/2 weave (roll S4 of the preceding table), compared to the standard plain weave and the others analyzed, improves the V50 values, representing effectiveness of ballistic protection, while lowering the number of layers required to obtain a given level KR1, a significant factor in improvement of the stab proof properties.

In the following table, taking the product S1 as a reference, the most significant characteristics of all the parameters analyzed so far are summarized, in particular:
the product S7 shows that with increase in the percentage of matrix 9, there is a decrease in the number of layers of laminate material 2 in the reference panel to obtain a given value of KR1-E2 (eighth column), partially sacrificing the ballistic properties with a lowering of the V50 value;
the product S4 shows that when the weave is changed, all the other characteristics of the material of the invention are maintained unchanged, while increasing both the ballistic performances (column V50) and the stab proof performances (column (KR1-E2);
the product S3 represents the fact that said performances can be obtained in a similar manner, also through a substantial change in fibers and, consequently, also in fabric 8:

| | | | | Area | Area | | |
|---|---|---|---|---|---|---|---|
| | | | | density of | density | | |
| | | | | single | of single | | |
| | Fiber | | | layer of | layer of | V50*@ 6.4 | KR1**E2 |
| Laminate | denier | Fabric | % | fabric | laminate | kg/m² | [kg/m²]- |
| material | (dtex) | weave | matrix | [g/m²] | [g/m²] | [m/s] | # layers |
| S1 | 1100 | Plain | 21 | 185 | 235 | 450 | 6.6-28 |
| S7 | 1100 | Plain | 35 | 185 | 285 | 400 | 6.6-23 |
| S4 | 1100 | Batavia 2/2 | 21 | 185 | 235 | 488 | 5.9-25 |
| S3 | 3300 | Plain | 20 | 260 | 365 | 426 | 6.6-18 |

in which:
*V50 test according to AEP2920 with 9 mm DM11 A1B2
**KR1 test according to the Home_Office_Body_Armour_Standard (2017), E2 = 36J

In practice it has been found that the invention achieves the intended aim and objects.

The laminate in roll form thus produced is aesthetically very similar to a sheet and has special characteristics.

The laminate can be rolled up and can be marketed in roll form.

The laminate according to the invention has stab proof properties similar to those of a conventional product but a decidedly improved ballistic resistance, as previously described.

The laminate according to the invention furthermore has improved flexibility (see first table above).

The roll form of the product allows all manufacturers, not equipped with infrastructures for shaping a large number of flat sheets, to work with MTP materials in the same way as they work with fabrics, unidirectionals, etc.

A further advantage of the present invention consists in the possibility of optimizing the waste, using the same templates, resulting from the fact that a continuous roll is available instead of single pieces.

The MTP material in roll form, produced according to the present invention, has the same stab proof and ballistic performances as the conventional sheet made of similar components, while having a greater flexibility.

Naturally the materials used, as well as the contingent size, can be any, according to requirements.

1. A process for the production of a flexible laminate material in roll form made by a roll to roll process, and characterized by a thermoplastic matrix made of one or more thermoplastic films and a woven fabric made of an aramid fabric characterized in that it entails direct continuous lamination, by simultaneously heating and compressing between them both a fabric (8) one or more thermoplastic films (9).

2. The process according to claim 1, characterized in that said lamination is carried out at a temperature of 100-250° C. and a pressure of 5-50 bar.

3. The process according to claim 2, characterized in that said lamination is applied for a time of at least 30 seconds.

4. (canceled)

5. A laminate material (2) for ballistic and stab proof protection, characterized in that it is a material in roll form made by a roll to roll process, and characterized by a thermoplastic matrix made of one or more thermoplastic films and a woven fabric made of an aramid fabric.

6. (canceled)

7. (canceled)

8. The material according to claim 5, characterized in that said fabric (8) consists of a high density textile fiber having denier ranging from 110 to 3300 dtex.

9. The material according to claim 8, characterized in that said fabric (8) is selected from woven fabrics composed of high tenacity and/or high modulus textile fibers typically used for ballistic applications or for the production of composites such as aramid fiber, high density polyethylene (UHMWPE), polypropylene, polyamide, polyimide, polyester, polyarylester, PBO, S-glass, E-glass, carbon fiber.

10. The material according to claim 9, characterized in that said matrix (9) is selected from thermoplastic resins having chemical composition based on polymers such as: polyethylenes, polyurethanes, polypropylene, polyamide, polyester, polyarylester, polyvinyl butyral, polycarbonate, phenolic, epoxy, phenoxy, polyurethane and acrylic resins.

11. The material according to claim 5, characterized in that the amount of matrix (9) in percentage based on the total weight of the laminate material (2) is between 10 and 45%.

12. The material according to claim 5, characterized in that it comprises an aramid fabric (8) weighing 185 g/m², with 1100 dtex fiber, and a polyethylene matrix (9) in amount of 21% by weight based on the total weight of the laminate material (2).

13. The material according to claim 5, characterized in that it comprises an aramid fiber with denier 670, 940, 1100, 1320, 3140, 3300 dtex; a content of matrix (9) between 15% and 25% for deniers above 3000 dtex and between 20% and 40% for intermediate deniers between 670 and 1320 dtex.
